(19) United States
(12) Patent Application Publication
(10) Pub. No.: US 2008/0015947 A1
(43) Pub. Date: Jan. 17, 2008

(54) ONLINE ORDERING OF ARCHITECTURAL MODELS

(76) Inventor: Lawrence W. Swift, Germantown, MD (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/614,320

(22) Filed: Dec. 21, 2006

Related U.S. Application Data
(63) Continuation-in-part of application No. 11/484,944, filed on Jul. 12, 2006.
Application No. 11/484,944 is a continuation-in-part of application No. 11/484,945, filed on Jul. 12, 2006.
Application No. 11/484,945 is a continuation-in-part of application No. 11/485,083, filed on Jul. 12, 2006.
Application No. 11/485,083 is a continuation-in-part of application No. 11/485,084, filed on Jul. 12, 2006.

(51) Int. Cl. G06Q 30/00

(52) U.S. Cl. 705/26

(57) ABSTRACT

The method for efficiently purchasing and customizing architectural scaled physical models comprises an online system of uploading data, choosing a standard model platform, determining model scale, orienting the model on the platform, choosing from standard options, confirming the order and selecting payment options. This method provides for efficient purchasing of models and the capture of key customer decisions points.

### CROSS REFERENCE TO RELATED APPLICATIONS

This application is a continuation-in-part of application Ser. No. 11/484,944, filed Jul. 12, 2006, currently pending. This application is also a continuation-in-part of application Ser. No. 11/484,945, filed Jul. 12, 2006, currently pending. This application is also a continuation-in-part of application Ser. No. 11/485,083, filed Jul. 12, 2006, currently pending. This application is also a continuation-in-part of application Ser. No. 11/485,084, filed Jul. 12, 2006, currently pending. Copending applications Ser. Nos. 11/484,944, 11/484,945, 11/485,083, and 11/485,084 are incorporated by reference herein, for all purposes.

### FIELD OF THE INVENTION

The present invention relates generally to a system and method for efficiently purchasing and customizing architectural scaled physical models. More specifically, the present invention relates to a system and method for purchasing and customizing architectural scaled physical models via a remote network connection.

### BACKGROUND INFORMATION

Architects, builders, and real estate developers have been building physical representations (models) of their design concepts for centuries to help them both develop their design and communicate that design to their clients. These models typically involve the fabrication of a building model (typically a residential house or commercial building), the fabrication of a site model of the property's terrain, and the placement of miniature facsimile trees and/or shrubs on the site model.

The building model is a scaled three dimensional model that represents the architect's design of the proposed building. These building models have traditionally been fabricated by hand using cardboard-type materials (“chipboard” is a popular medium) by architects and/or model builders using X-ACTO® knives and glue to manufacture a miniature scaled model of the building design. Other materials can also be used such as plastics or metals, which are often cut to size using laser cutters.

The site models are typically scaled topographical representations of the land on which the building is to be constructed. The typical approach to constructing these site models is to cut out and stack-up cardboard layers, with each cut out layer representing a land elevation contour.

Once the building model and site model have been integrated together to form a combined model, the final assembly stage of the combined model is the placement of miniature foliage representing trees and/or shrubs. The miniature foliage may be simply decorative (i.e., randomly place on the site model with no correlation to the actual location of plants), or it may be a representation of the actual positioning of foliage that is intended to occupy the site with the building as part of an architect's landscape design.

Architectural models made in this traditional way are very time consuming to complete, often taking several weeks to finish. This is particularly vexing due to the fact that substantial, late changes may be made to the design that may necessitate a new model be built. The architectural models can also often be of mediocre quality due to the manual nature of the process which requires talent, skill, and care to be done well.

The traditional tangible statement of the architect's design concepts has been with the hand drafting of “blue prints” type drawings. With the advent of computer aided design (CAD) software tools into the architect community, architects have begun to use computer software programs to design buildings, replacing this traditional hand-drawn approach. Initially, these architectural CAD tools were two dimensional (2D) tools that simply brought the hand drafting process onto the computers. More recently, the architectural industry has begun to adopt three dimensional (3D) CAD tools to perform architectural design work.

Despite the technology advances, there remain logistical challenges to the efficient supply of architectural models that result in increase costs which cause the market for such models to remain substantially limited. For engineers and architects (and even more so for the general public) it remains a challenge to locate and conduct business with a model making firm that can quickly provide an architectural model at a reasonable cost, even if 3D CAD (three-dimensional Computer Aided Design) design files have already been prepared. What is needed to expand the market for architectural models is a way to overcome logistical inefficiencies, and thereby reduce the cost of doing business for this product.

### SUMMARY OF THE INVENTION

The subject of this invention is to utilize the availability of electronic architectural design data (i.e. CAD data) to allow for the efficient purchasing and customization of architectural scaled physical models.

An embodiment of the present invention comprises a method for efficiently purchasing and customization of architectural scaled physical models. The method involves Customers (architects, builders and/or developers) uploading to an electronic store (i.e., an Internet web site) the electronic design data (i.e. by way of example, Computer Aided Design or “CAD” data) for a residential and/or commercial structure (both building model data and site model data), selecting the model platform size from a selection of standard size options, determining the scale of the model, determining the orientation of the model on the platform, and choosing among several options that may be offered. The Customer may choose from among standardized model options (by way of example, paint color schemes, foliage style, foliage placement, etc.), choose optional companion products (by way of example, frame style, dust cover model wall hanging attachments, roll-around model storage systems, etc.), and choose shipping methodology. The Customer then pays for the model(s) online.

### BRIEF DESCRIPTION OF THE DRAWINGS

FIG. 1 illustrates an example of system architecture used for practice of embodiments of the invention.

FIG. 2 illustrates a flow chart describing a manufacturing process of an embodiment of the invention.

FIG. 3 illustrates an exploded view of how a building model is integrated with a site model according to embodiments of the invention.

FIG. 4 illustrates a flow chart describing an ordering process of an embodiment of the invention.

FIG. 5 illustrates the process of scaling the size of an architectural model with respect to a selected platform, with examples of model scale at 10^{th}, 14^{th} and 16^{th} relative scales (meaning in this example that 1 inch=10 feet, 14 feet, or 16 feet).

FIG. 6 illustrates the process of orienting an architectural model on a selected platform.

FIG. 7 illustrates the process of positioning a model on a selected platform.

### DETAILED DESCRIPTION

One aspect of the invention is the use of architectural electronic design data to efficiently order and customize scaled physical models. This can effectively be practice via a web portal through which Customers access an ordering facility that accepts the order, interacts with the Customer regarding model options, accepts payment, and engages fulfillment of the order.

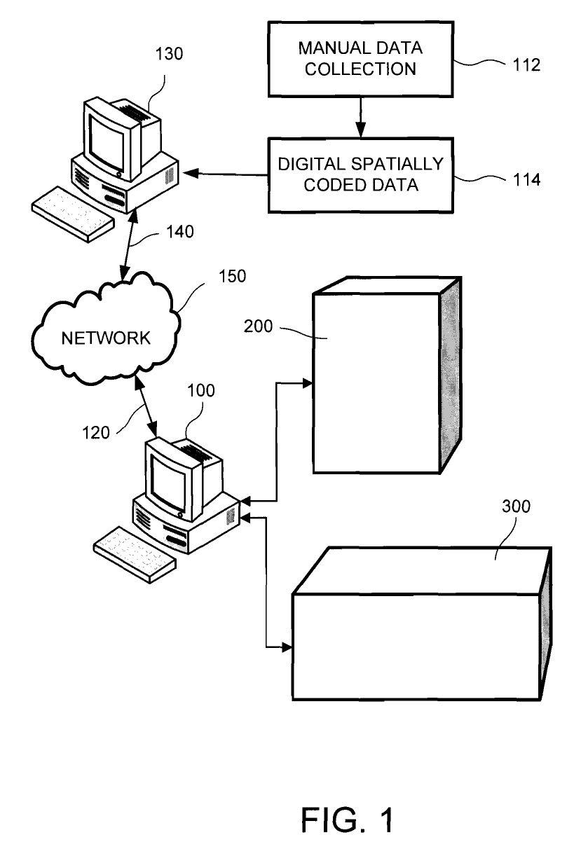

Referring to FIG. 1, system architecture of apparatus for practicing embodiments of the present invention is illustrated. A computer 100 is interfaced to both an additive manufacturing machine 200 and a subtractive manufacturing machine 300. The computer 100 handles electronic files containing data regarding both a building model and a site model and commands manufacture of models by the additive manufacturing machine 200 and the subtractive manufacturing machine 300 based on the electronic files. The data regarding building and site models by a Customer may be loaded from a remote origin via a communication channel 120 or portable media, or may be generated on the computer 100. In practicing the present invention via a communication channel 120, 140, spatially coded data files 114 and/or commands from a Customer's computer 130 are receive via a network 150 (e.g., the Internet) and are used as a basis to command operation of CNC subtractive manufacturing machines 300 and/or additive manufacturing machines 200.

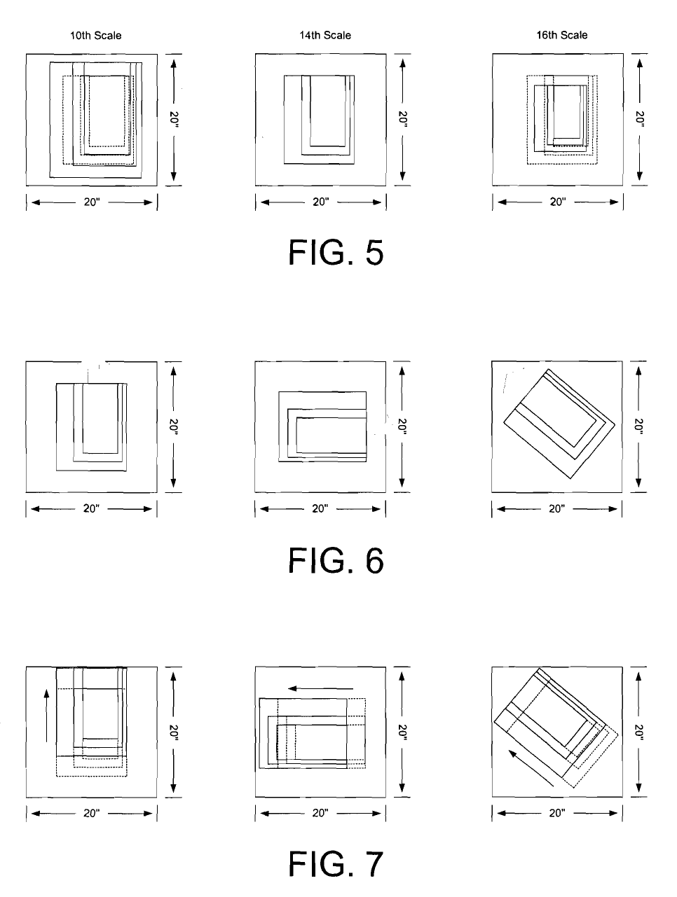

One aspect of the invention is a process for determining the scale of the site model portion (or base) of an architectural scaled physical model so as to maximize the efficiency of automated model manufacturing processes. The architectural model has both a building model portion and the site model portion, with the building model (a model of the building according to an intended design) sitting atop the site model (a model of the land the building is to occupy). The process of scale determination (refer to FIG. 5) focuses on standardizing the model's scale decision based on the selection of the material from which the site model is fabricated.

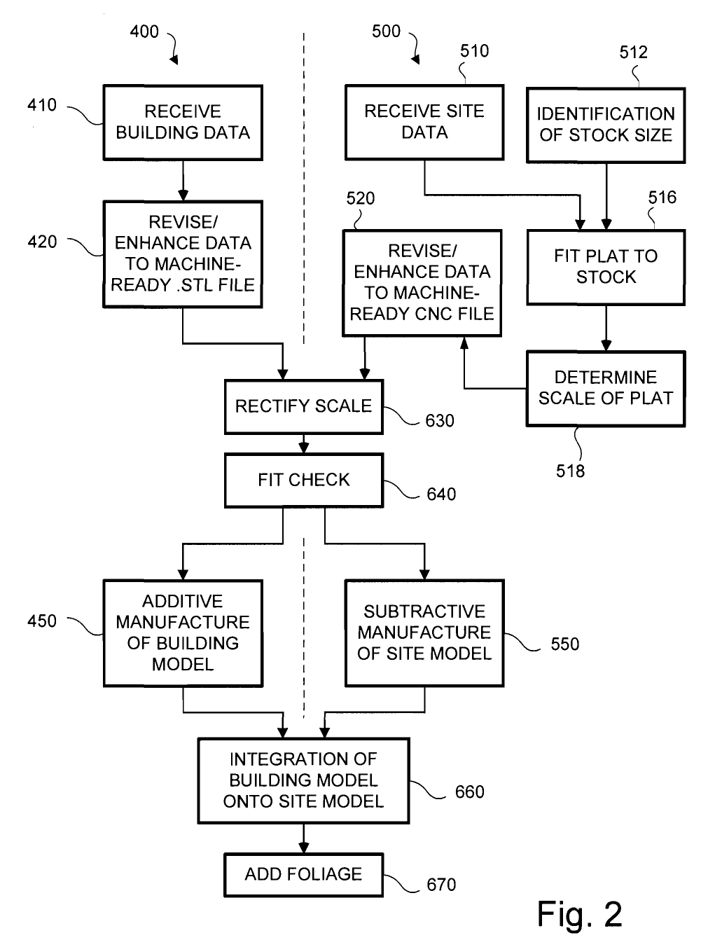

Referring to FIG. 2, the architect/customer initially chooses 512 from standardized block material from which the site model is to be fabricated. Once the material size is chosen, the scale of the model is established so that the site model is “fitted” 516 to the chosen material.

The topography of the property upon which the architect intends to build a structure is typically archived by the state and or county, and is often documented by a “plat.” From this plat, the length (x variable), width (y variable) and height (z variable) of the property can be established. In the exemplary situation, a Customer chooses to outsource the building of an architectural scaled model (which integrates both a building model and a site model) by a model manufacturing company (model builder) that is remotely accessible via network communication. This model builder manufactures the site model from polyurethane modeling boards. These are solid planks made of polyurethane plastic, which can be machined with milling machines or routers controlled with computer numerical controlled (CNC) technology. Other materials can also be used, such as medium density fiberboard (MDF). For purposes of this example, the model builder maintains an inventory of standard-sized polyurethane boards in two sizes: 20″×20″×6″ and 15″×15″×6″. The Customer chooses whether the site model shall be machined from the 20″×20″×6″ stock or the 15″×15″×6″ stock. For further purposes of this example, the 20″×20″×6″ stock is chosen.

Once the stock size is determined 512, then the site model is “fitted” 516 to the stock in such a way that:
the x, y, and z dimension relationship of the plat is maintained in ratio;
the scale of the plat on the stock (refer to FIG. 5) is defined;
the orientation of the plat on the stock (refer to FIG. 6) is determined; and
the position of the plat on the stock (refer to FIG. 7) is determined.

Various possible scaled dimensions of the plat relative to the stock are portrayed in FIG. 5. Various possible orientations of the plat positioned within the dimensions of the stock are portrayed in FIG. 6. Various possible positions of the plat positioned within the dimensions of the stock are portrayed in FIG. 7.

Fitting of the site model within the stock can be performed 516 in a commercially available software program that allows for the visualization and scaling of objects, such as Rhino, FormZ, AutoCAD, or SolidWorks. It should be understood, however, that the invention is not limited to use of these commercial products and may use other means to perform fitting. Alternatively, fitting of the site model within the stock can be performed on paper and later converted to a 3D CAD file. As another alternative, network enabled software such as that disclosed by the same inventor as this application in the related application entitled “Building of Scaled Physical Models” (application Ser. No. 11/484,945, filed Jul. 12, 2006).

Referring further to FIG. 2, a flowchart for a process by which architectural electronic design data can be used to build scaled physical models is illustrated. The process has a process flow 400 for making the building model, which is mostly separate from a process flow 500 for making the site model. The building model process flow 400 and the site model process flow 500 are conceptually parallel to one another and may be executed substantially contemporaneously with one another.

The building model process flow 400 begins the reception 410 of building model data from a customer (e.g., an architect or designer). The format the building model data is received in is any format known to those skilled in the art so long as it can be transformed or translated into a format that is compatible with CAD software. For example paper format blueprints can be scanned 112 (refer to FIG. 1) and captured to be placed into an electronic form. Non-3D CAD formats are translated into a 3D CAD format either by conversion or design translation. Thus, 2D CAD files, 3D CAD files, and .stl files (or any other file format that allows for the capture of geometric shapes) can all be received into and utilized for a process according to this invention. For ease of description, the process as described below will presuppose that the building model data has been either delivered in, or has been converted into, the standard stereolithography output format which is known in the CAD art and for which the files have the file extension “.stl” (a standard output format for almost all 3D CAD software programs).

A building model .stl file received from the Customer contains a complete description of the building model design, and is output from the architect's 3D CAD software package. Once received, the .stl file is examined to ensure suitability for manufacturing in additive manufacturing equipment, which is commonly referred to as “rapid prototyping” equipment. Three dimensional printers are additive manufacturing machines suitable for implementing the invention, and are commercially available as products manufactured by Z Corp, Stratasys, and 3D Systems.

A search of the data file is conducted for anomalies that would prevent successful manufacturing of the building model “part.” Any such anomalies identified are modified or repaired 420 so that manufacture of the model can be accomplished. Examples of repairs that are typically effected include making parts be “water tight” (i.e., no gaps, holes or voids in the model), and insuring that no features are below minimal manufacturing tolerances. Commercially available software programs are available for this purpose, such as Materialise's Magics, CADSpan (www.cadspan.com) or proprietary analysis software may be used. Additional changes to the electronic model (e.g., changing the size of railings or fence posts) may be useful and can be accomplished with the use of 3D CAD programs. Examples of 3D CAD programs that can be successfully used to do this are Rhino, FormZ, AutoCAD, and SolidWorks. As an alternative, .stl manipulation programs (such as Magics) can be used to make the changes to revise the building model data file.

Once the fitting of the plat within the stock is complete, the scale is determined 518 by dividing the scaled plat (as fitted to the stock) by the full-scale (1:1) plat. This calculation provides the scale ratio of the site model. Once the building model .stl file is determined to be suitable for manufacturing, the same scale ratio as for the site model is applied 630 to the full-scale building design dimensions will provide the scale of the building model. Most all 3D CAD software programs (e.g., Rhino, FormZ, AutoCAD, SolidWorks) can easily scale designs based on operator-defined ratios. Additionally, a virtual fit check 640 is made to ensure that the building model can be attached to the site model.

Once the scales are rectified 630 and if the fit check 640 is met, the building model .stl file is submitted 450 to the additive manufacturing equipment to be built. The process this equipment performs is referred to as an “additive” process, since the part (in this case the building model) is typically built up one layer at a time by the rapid prototyping manufacturing equipment. Various types of media (e.g., plastic or plaster) can be used by the equipment to make the building models, and the media may be colored depending on the manufacturer and rapid prototype equipment selected.

Various post processing efforts are performed, depending on the additive manufacturing equipment selected. For example, when using a Z510 model three dimensional printer manufactured by Z Corp., once the building model is built up and has had suitable time to dry, the part is excavated from the Z510 machine and “de-powdered” to remove all excess material. The de-powdering is done because the Z510 uses a plaster-like powder material as its medium to build the parts it makes. The de-powdered building model can then be “infiltrated” with any of a variety of waxes, urethanes, or resins, depending on the desired surface characteristics for the building model. Once infiltrated, the building model may be hand finished as necessary to ensure the desired look, quality and finish.

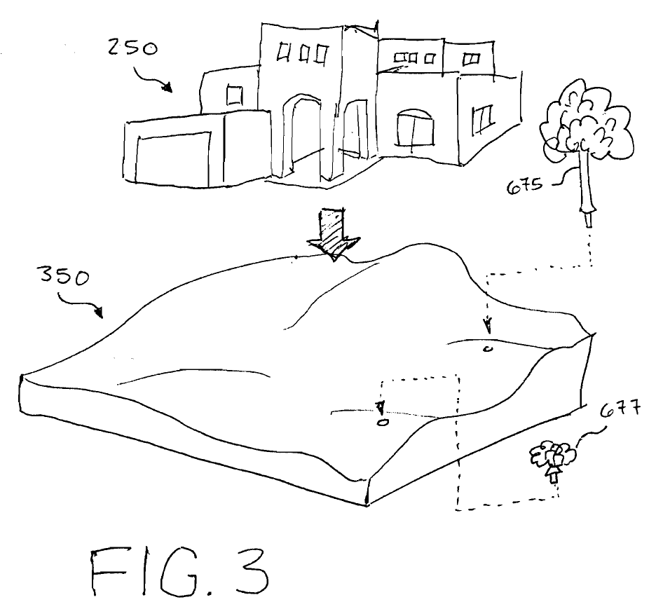

After the post processing efforts have been completed, the fabricated building model 250 is ready to be attached 660 to the site model 350 (refer to FIG. 3).

The site model process flow 500 (refer to FIG. 2) can be performed in parallel to the building model process flow 400 to minimize overall process completion time.

The site model process flow 500 begins with the reception 510 of site model data from the Customer (e.g., architect, designer, or survey engineer). The site model data can be in various formats. Either paper format (e.g., plats) or electronic format (e.g., 2D CAD files, 3D CAD files, .stl files, etc.) can be utilized in the process. In order to be manufactured, non-3D formats must be translated into 3D formats, either by conversion or design translation. For ease of description, the process as described below will presuppose that the site model data has been either delivered in, or has been converted into, the standard stereolithography output format which is known in the CAD art and for which the files have the file extension “.stl”. Once ready, the stl file is fitted (i.e., sized and oriented) 516 with respect to the chosen stock size.

Once fitted 516 to the chosen stock, the stl file is converted 520 into a programming language (e.g., G-Code) that is used by subtractive manufacturing equipment, such as a CNC machine tool (e.g., a CNC milling machine or a CNC routing machine). This conversion can be done with off-the-shelf CAM (Computer Aided Manufacturing) software programs such as ArtCAM by Delcam plc (www.artcam.com).

This manufacturing equipment is described as performing a “subtractive” process in that the part (in this case the site model) is created by taking material away from a block of material with milling or routing machinery. The site models can be made from various types of material, such as plastic modeling boards, Styrofoam, Medium Density Fiberboard or blocks of wood.

When the subtractive manufacturing equipment completes formation of the site model, it can then be hand finished as necessary to ensure the desired look, quality, and finish, after which the site model 350 is ready to be physically integrated 660 with the building model 250 (refer to FIG. 3).

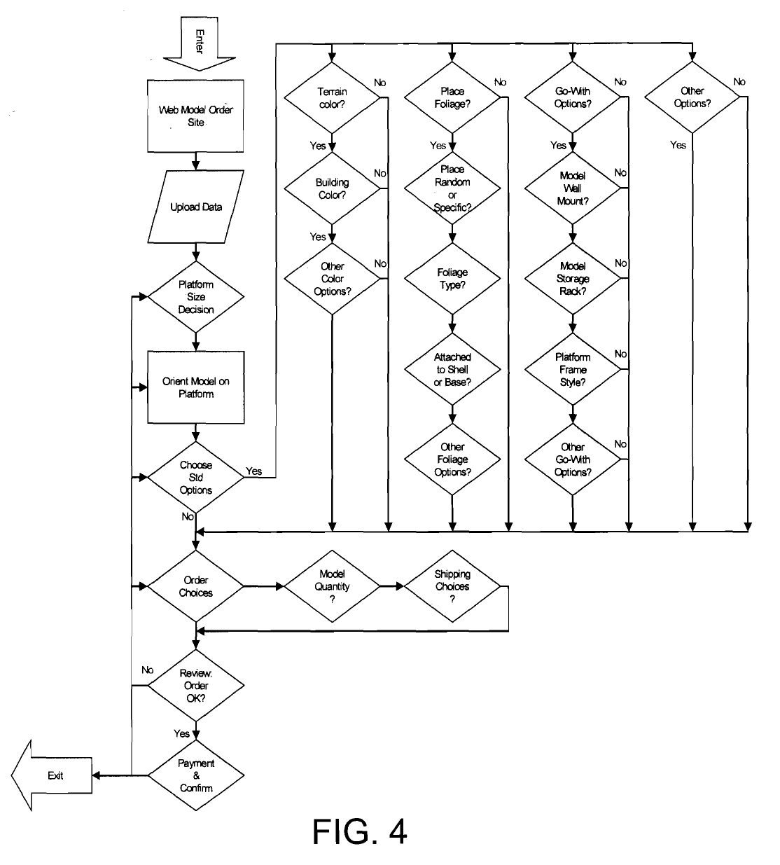

Referring to FIG. 4, a flowchart depicts an embodiment of the present invention as a process that automates much of the transactional tasks associated with purchasing scaled physical models and enabling the customer to customize elements of the model presentation within pre-established standardized boundaries. In the process according to this flowchart, data is uploaded from the customer (architect, builder, real-estate developer, etc.) describing the building model and the site model. This embodiment provides a process by which architectural electronic design data can be used to efficiently purchase and customize scaled physical models.

Once the web site has been accessed, model data may then be uploaded. As one mode of practicing the invention, CAD data describing the design detail of the building model and the site model is uploaded through a secure web page. The data uploaded is in electronic format (i.e., 2D CAD files, 3D CAD files, stl files, etc.) can be received into the on-line Process.

Next, one of plural standardized platforms is chosen. The customer chooses from among a set of standardized platforms, the platforms defining the overall length and width of the model they will receive. Referring to FIG. 5, a choice of a 20″×20″ platform is shown as an example. Pricing for each platform choice may be available to help facilitate the selection decision. By placing this selection choice early in the model-building process, the need for follow-up discussions with the customer is minimized.

The customer is provided with a choice of the scale of the model (i.e., size of model relative to full size of the building) and view how that size works with the chosen platform size. FIG. 5 illustrates model scale examples at 10^{th}, 14^{th} and 16^{th} relative scales (meaning in this example that 1 inch=10 feet, 14 feet, or 16 feet). Like the step of choosing a platform size, it is useful to time the choice of scale early in the model-building process so as to minimize the need for follow up discussions with the customer.

After determining the model size through scaling, the customer can choose how they wish to locate the model on the platform in terms of both direction and position on the platform. Referring to FIG. 6, choices for orienting a model on a platform are illustrated. FIG. 7 illustrates the process of positioning of the model on the platform. These choices as to placement are usefully presented early in the model-building process so as to minimize the need for follow up discussions with the customer.

Other choices related to orientation and positioning of the model on the platform may include selecting the direction of a customer logo on the model and placement of a compass rose.

Once the choices concerning platform size, scaling, orientation and position have been addressed, the customer is presented with choices from a set of standardized options relating to the look-and-feel of the model. Choices may also be presented regarding companion products. Examples of look-and-feel options include:

painting color schemes for the topography,

applying color to the building,

application of miniature foliage.

Examples of companion product options include:

choice of frame style,

addition of a dust-cover,

purchase of storage devices,

purchase of hardware to mount the model on a wall.

### Pricing for each of these options, as well as display of explanatory images, may be presented along with the choices to help facilitate the decision.

The customer is also presented with a number of choices regarding modeling of foliage. Although placement of model foliage items 675, 677 on the site model 350 is not required, it is a popular option since landscaping plays a meaningful role in building planning. The customer has the option of omitting foliage, having model foliage items placed randomly, specifying placement of model foliage items according to a landscape plan (identifying location, type and size of foliage) of their own design, or modeling of a realistic representation of the foliage as currently exists on the site.

In order to handle foliage modeling, either a foliage survey or landscaping plan of the property can be used or, an aerial and/or satellite imagery of the site model property may be obtained to perform digital image classification of the type of vegetation and the vegetations' location on the site. Examples of data sources for aerial and/or satellite imagery can be found on commercial web sites such as http://earth.google.com/, http://www.terraserver.com, and http://www.airphotousa.com, as well as web sites of government agencies responsible for agriculture or mapping, such as http://geography.usgs.gov/partners/viewonline.html. Other public and private sources for such data are also available. When used in the present invention, the satellite and/or aerial imagery data may be geo-referenced. Digital sources of imagery data (either satellite or aerial) are preferred, particularly those having a resolution of about 1 meter per pixel or less, those that are in color, and those that are taken with LIDAR (LIght Detection And Ranging) technology, although this is not meant as a limitation. The better the image quality is, the better it will provide meaningfully enhanced quality of foliage analysis.

Identification of foliage type and location is preferably conducted via one or more processes as disclosed in co-pending application Ser. No. 11/485,083, filed Jul. 12, 2006 and entitled “Identification of Terrestrial Foliage Location, Type, and Height for Architectural Models,” and which is hereby incorporated by reference into this application for all purposes. Identification of foliage type and location is satisfactorily performed using commercially available software. Algorithms for the identification of foliage from satellite and/or airborne images have been developed by Pollock (1994), Gougeon (1995), Brandtberg and Walter (1999), Wulder et al. (2000), and McCombs et al. (2003). In general, these algorithms perform digital image classification using the spectral information from the digital and/or airborne satellite imagery, and classify each individual pixel based on spectral information. This type of classification is generally termed “spectral pattern recognition.” The objective is to assign all pixels in the image to particular classes or themes (i.e. coniferous forest, deciduous forest, etc.). Commercial software packages that provide some functionality of this type include eCognition Forester by Definiens and Feature Analyst® by Visual Learning Systems.

As an alternative, or as a supplement, to software as described above, direct personal observations of the foliage may be used to model the type, height, and location. Such direct data gathering 112 (refer to FIG. 1) is labor intensive, and thus usually disfavored, but may be a useful substitute or adjunct when readily available image data for the site is deficient or lacking. Such information would subsequently be entered into a data file in for later manipulation.

Information identified by software (or through direct observation if need be) includes (1) identification of all the significant vegetation on the site, (2) the longitude and latitude location of each vegetation identified, (3) the type of each identified vegetation (i.e. evergreen, deciduous, shrub), and (4) the estimated height of each item of vegetation identified. This information is then integrated into the architect's site model 350 to provide vegetation placement points in the site model 350 for placement of model foliage items 675, 677.

Once the product has been defined via the process described above, the customer may then choose standard order fulfillment options like quantity of models desired, shipping method, and other business related choices. Display of pricing for these selections would be available to help facilitate the decision.

Once the product is defined and the ordering choices are made, the customer may then be presented with an opportunity to review the order in its entirety to insure accuracy and completeness of the deliverable product(s) and pricing.

After the customer has confirmed the order, he or she may then choose from standard payment options (by way of example and without limitation, credit card, cash on delivery, PayPal®, etc.). Once payment method is chosen and accepted, then the system would provide confirmation to the customer via email or other methodology confirming that the order has been received.

The embodiments described above provide several benefits. Compared to prior art methods for purchasing scaled architectural model, the above-described embodiments allow the customer to efficiently transfer their data, make on-line decisions about model orientation, choose options, and make payment for the model desired to be built. These embodiments also capture useful model-building information from the customer at an early stage of the ordering process to insure accurate manufacturing of the model while minimizing the time spent on follow up questions with the customer to obtain clarification.

A method for efficiently purchasing and customizing architectural scaled physical models has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

What is claimed is:

1. A method for commercial production of a customized architectural scaled physical model, the method comprising:
accepting from a customer uploaded building design data and topography data;
accepting from the customer an online selection regarding scale of the architectural scaled physical model;
accepting from the customer an online selection regarding a standard platform size upon which to build the architectural scaled physical model;
accepting from the customer an online selection regarding orientation of the architectural scaled physical model upon a platform of the selected size;
completing online ordering by receiving payment;
manufacturing the architectural scaled physical model according to customer selections via automated manufacturing equipment; and
providing the manufactured architectural scaled physical model to the customer.

2. The method for commercial production of a customized architectural scaled physical model of claim 1, further comprising:
accepting from the customer selection of an optional model features from a predetermined list of standard options.

3. The method for commercial production of a customized architectural scaled physical model of claim 1, wherein completing the online order comprises receiving from the customer confirmation of accuracy and completeness of the order.

4. The method for commercial production of a customized architectural scaled physical model of claim 3, wherein completing the online order further comprises transmitting order confirmation.

5. A system for commercial production of a customized architectural scaled physical model, the system comprising:
a general purpose computer connected to receive an order from a customer via a network, the computer comprising:
a processor, and
memory connected to the processor and including software instructions adapted to enable the processor to perform operations comprising:
accepting from a customer uploaded building design data and topography data,
accepting from the customer an online selection regarding scale of the architectural scaled physical model,
accepting from the customer an online selection regarding a standard platform size upon which to build the architectural scaled physical model,
accepting from the customer an online selection regarding orientation of the architectural scaled physical model upon a platform of the selected size,
completing online ordering by receiving payment,
manufacturing the architectural scaled physical model according to customer selections via manufacturing equipment automated by the computer, and
providing the manufactured architectural scaled physical model to the customer;
additive manufacturing equipment connected to receive from the computer a building model file to produce a building model;
subtractive manufacturing equipment connected to receive from the computer a site model file to produce a site model;
wherein the customized architectural scaled physical model results from integration of the produced building model together with the produced site model.

6. A computer program product for enabling production of an architectural scaled physical model, the computer program product comprising:
software instructions for enabling the computer to perform predetermined operations, and a computer readable medium embodying the software instructions;
wherein the predetermined operations comprise:
accepting from a customer uploaded building design data and topography data,
accepting from the customer an online selection regarding scale of the architectural scaled physical model,
accepting from the customer an online selection regarding a standard platform size upon which to build the architectural scaled physical model,
accepting from the customer an online selection regarding orientation of the architectural scaled physical model upon a platform of the selected size,
completing online ordering by receiving payment,
manufacturing the architectural scaled physical model according to customer selections via manufacturing equipment automated by the computer, and
providing the manufactured architectural scaled physical model to the customer.

7. An architectural scaled physical model comprising:
a site model; and
a building model integrated with the site model to form the architectural scaled physical model;
wherein the site model and the building model are prepared according to the method:
accepting from a customer uploaded building design data and topography data;
accepting from the customer an online selection regarding scale of the architectural scaled physical model;
accepting from the customer an online selection regarding a standard platform size upon which to build the architectural scaled physical model;
accepting from the customer an online selection regarding orientation of the architectural scaled physical model upon a platform of the selected size;
completing online ordering by receiving payment;
manufacturing the building model based on the building design data and according to customer selections via automated manufacturing equipment; and
manufacturing the site model based on the topography data and according to customer selections via automated manufacturing equipment; and
integrating the building model with the site model to form a manufactured architectural scaled physical model.
